(19) United States
(12) Patent Application Publication
(10) Pub. No.: US 2024/0378075 A1
(43) Pub. Date: Nov. 14, 2024

(54) METHOD, NON-TRANSITORY COMPUTER-READABLE STORAGE MEDIUM AND DEVICE OF VIRTUAL MACHINE RESOURCE ALLOCATION

(71) Applicant: Beijing Bytedance Network Technology Co., Ltd., Beijing (CN)

(72) Inventors: Liang DENG, Beijing (CN); Yongji XIE, Beijing (CN); Hangjing LU, Beijing (CN); Xiongchun DUAN, Beijing (CN); Wen CHAI, Beijing (CN); Yu ZHANG, Beijing (CN); Jian WANG, Beijing (CN)

(21) Appl. No.: 18/690,232

(22) PCT Filed: Oct. 11, 2022
(86) PCT No.: PCT/CN2022/124536

§ 371 Date: Mar. 7, 2024

(30) Foreign Application Priority Data
Oct. 20, 2021 (CN) 202111222020.X

(51) Int. Cl. G06F 9/455; G06F 9/50

(52) U.S. Cl. CPC G06F 9/45558; G06F 9/5027

(57) ABSTRACT

The disclosure relates to a method, non-transitory computer-readable storage medium, and device of virtual machine resource allocation. The method includes: when virtual machines are created in a physical machine, allocating corresponding bare machine devices to the virtual machine, the bare machine devices being obtained by segmenting physical resources of the physical machine, and the virtual machine being in one-to-one correspondence with the bare machine devices; configuring the operation mode of the bare machine devices into a non-root mode; and switching the operation mode of a CPU of the physical machine to the non-root mode so as to start the virtual machines in the bare machine devices.

### CROSS-REFERENCE TO RELATED APPLICATIONS

The present application claims priority to Chinese Patent Application No. 202111222020.X, filed on Oct. 20, 2021, entitled “METHOD, APPARATUS, MEDIUM AND DEVICE OF VIRTUAL MACHINE RESOURCE ALLOCATION”, which is hereby incorporated by reference in its entirety.

### FIELD

The present disclosure relates to the field of virtual technologies, and particularly, to a method, apparatus, medium and device of virtual machine resource allocation.

### BACKGROUND

As the computer technology develops, there is an increasing demand for virtualization. A virtual machine (VM) refers to a complete computer system which is simulated by software, has complete hardware system functions and runs in a completely isolated environment. Each virtual machine may be operated as if it were a physical machine, which can reduce the cost of purchasing software and hardware devices to a certain extent, and improve the security of a physical machine system.

In current virtualization technologies, virtual machine monitors may use hardware virtualization extensions to provide resources for virtual machines. Although the hardware virtualization technology reduces the number of times that the virtual machines are trapped by the virtual machine monitors, it still has a lot of additional overhead such as virtualizing hardware, which significantly negatively impacts the performance of physical and virtual machines.

### SUMMARY

This section is provided to briefly introduce ideas, which will be described in detail in the following detailed description section. This section is not intended to identify key or necessary features of the claimed technical solution, nor is it intended to limit the scope of the claimed technical solution.

In a first aspect, the present disclosure provides a method of virtual machine resource allocation, the method comprising:
Allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
Configuring an operation mode of the bare-metal machines to a non-root mode;
Switching an operation mode of a CPU of the physical machine to the non-root mode so as to start the virtual machines in the bare-metal machines.

In a second aspect, the present disclosure provides an apparatus of virtual machine resource allocation, the apparatus comprising:
An allocating module, for allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
A first configuring module, for configuring an operation mode of the bare-metal machines to a non-root mode;
A first switching module, for switching an operation mode of a CPU of the physical machine to the non-root mode so as to start the virtual machines in the bare-metal machines.

In a third aspect, the present disclosure provides a computer-readable storage medium storing a computer program thereon, wherein, the computer program, when is executed by a processor, implements steps of the method according to the first aspect.

In a fourth aspect, the present disclosure provides an electronic device, comprising:
a storage device having at least one computer program stored thereon;
one or more processing devices for executing the at least one computer program in the storage device to implement steps according to the first aspect.

Therefore, in the above technical solution, allocate corresponding bare-metal machines to virtual machines when the virtual machines are created in a physical machine, configure an operation mode of the bare-metal machines to a non-root mode, and switching an operation mode of a CPU of the physical machine to the non-root mode so as to start the virtual machines in the bare-metal machines. Therefore, according to the above technical solution, the bare-metal machines are obtained by segmenting physical resources of the physical machine, and the virtual machines are in one-to-one correspondence with the bare-metal machines. Each virtual machine may run in its corresponding independent bare metal device, and multiple virtual machines do not interfere with each other, thereby achieving resource isolation and performance isolation of the virtual machine. Moreover, by configuring the operating mode of the bare metal device as non-root mode, configure the operating mode of the CPU of the physical machine to switch to non-root mode, realizing the direct application of the virtual machine to the physical resources in the physical machine, effectively reducing the overhead of hardware virtualization, and ensuring the high performance of TCE-metal and the virtual machine.

Other features and advantages of the present disclosure will be described in detail in the following detailed description.

### BRIEF DESCRIPTION OF THE SEVERAL VIEWS OF THE DRAWINGS

The above and other features, advantages and aspects of various embodiments of the present disclosure will become more apparent in combination with the accompanying drawings and with reference to the following Detailed Description. The same or similar reference signs indicate the same or similar elements throughout the accompanying drawings. It should be understood that the accompanying drawings are schematic and components and the elements are not necessarily drawn to scale. In the accompanying drawings:

FIG. 1 is a flowchart of a virtual machine resource allocation method provided according to an implementation mode of the present disclosure;

FIG. 2 is a schematic diagram of bare metal machines obtained by segmentation in a physical machine provided according to an implementation mode of the present disclosure;

FIG. 3 is a block diagram of a virtual machine resource allocation apparatus provided according to an implementation mode of the present disclosure; and

FIG. 4 shows a structural block diagram of an electronic device suitable for implementing embodiments of the present disclosure.

### DETAILED DESCRIPTION

The following embodiments of the present disclosure will be described in more detail with reference to the accompanying drawings. Although certain embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps described in the method implementation method of this disclosure can be executed in different orders and/or in parallel. In addition, the method implementation method can include additional steps and/or omit the steps shown. The scope of this disclosure is not limited in this regard.

The term “including” and its variations as used herein are open-ended, i.e. “including but not limited to”. The term “based on” means “based at least on part on”. The term “one embodiment” means “at least one embodiment”; the term “another embodiment” means “at least one other embodiment”; and the term “some embodiments” means “at least some embodiments”. Relevant definitions of other terms will be given in the following description.

It should be noted that the concepts of “first” and “second” mentioned in this disclosure are only used to distinguish different devices, modules, or units, and are not used to limit the order or interdependence of the functions performed by these devices, modules, or units.

It should be noted that the modifications of “one” and “multiple” mentioned in this disclosure are illustrative and not restrictive. Those skilled in the art should understand that unless otherwise specified in the context, they should be understood as “one or more”.

The names of the messages or information exchanged between multiple devices in this public implementation are for illustrative purposes only and are not intended to limit the scope of these messages or information.

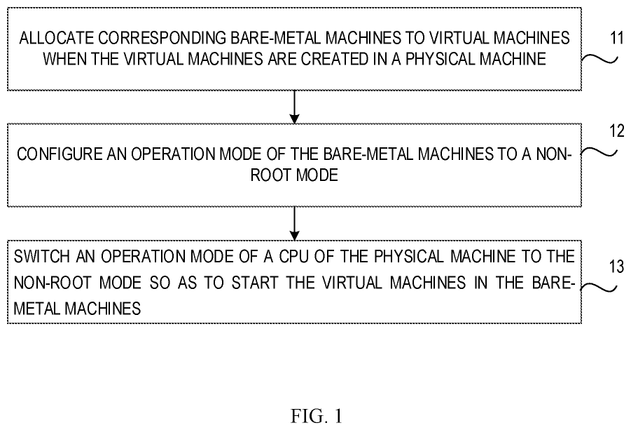

FIG. 1 is a flowchart of a virtual machine resource allocation method provided according to an implementation mode of the present disclosure. As shown in FIG. 1, the method includes the following steps.

In step 11, when virtual machines are created in a physical machine, corresponding bare-metal machines are allocated to the virtual machines, wherein the bare-metal machines are obtained by segmenting physical resources of the physical machine, and the virtual machines are in one-to-one correspondence with the bare-metal machines.

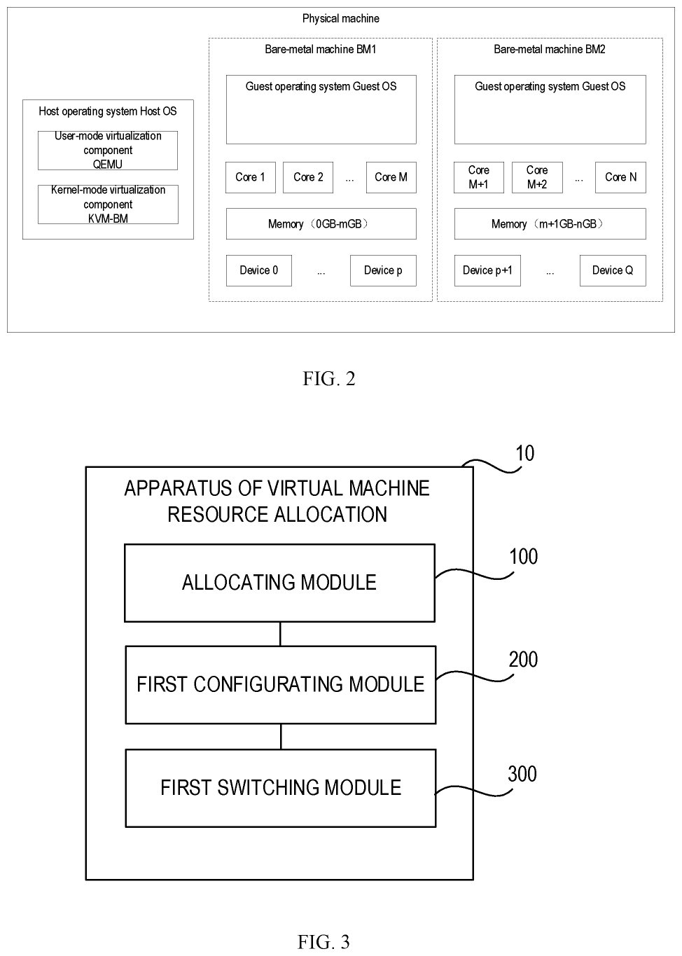

As used herein, in the related art, resources may be provided for virtual machines through CPU virtualization, memory virtualization, I/O device virtualization, and the like. In the embodiments of the present disclosure, as shown in FIG. 2 which is a schematic diagram of bare metal machines obtained by segmentation in a physical machine. Corresponding physical resources of the physical machine may be segmented in the physical machine to obtain one or more bare-metal machines (BMs), and resources in different bare-metal machines are different.

As shown in FIG. 2, BM1 includes cores 1 to M and BM2 includes core M+1 and other cores; and BM1 includes memories 0 GB to mGB and BM2 includes memories m+1 GB and subsequent memories, so as to achieve resource isolation and performance isolation between different bare-metal machines.

In step 12, an operation mode of the bare-metal machines is configured to a non-root mode. A kernel-mode virtualization component (i.e., KVM-BM in FIG. 2) may be configured in the non-root mode through a virtual machine control structure (VMCS) in X86 hardware virtualization. The VMCS is a key data structure in an Intel x86 processor that implements CPU virtualization and records the state of a vCPU. In the VMCS architecture, by introducing a root operation mode and a non-root operation mode, the vCPU may directly run on a logical CPU, and when switching between the root mode and the non-root mode occurs, the VMCS may be used to configure a state and an execution environment of the logical processor for which switching occurs currently. Thus, the simulation of vCPU operation may be eliminated and the processor performance may be improved.

In step 13, an operation mode of a CPU of the physical machine is switched to the non-root mode so as to start the virtual machines in the bare-metal machines.

Exemplarily, the operation mode of the CPU of the physical machine may be switched to the non-root mode through the kernel-mode virtualization component and the virtual machines are started in the bare-metal machines. Since the operation mode of the bare-metal machines is the non-root mode, that is, operating systems of the virtual machines are always in the non-root mode, there is no virtualization overhead caused by exit from the non-root mode, thereby achieving virtualization and pass-through application of the physical resources of the physical machine.

Thus, in the above technical solution, when the virtual machines are created in the physical machine, the corresponding bare-metal machines are allocated to the virtual machines, the operation mode of the bare-metal machines is configured to the non-root mode, and the operation mode of the CPU of the physical machine is switched to the non-root mode so as to start the virtual machines in the bare-metal machines. Thus, through the above technical solution, the bare-metal machines are obtained by segmenting the physical resources of the physical machine and the virtual machines are in one-to-one correspondence with the bare-metal machines. Therefore, each virtual machine may operate in a corresponding independent bare-metal machine thereof respectively and a plurality of virtual machines does not interfere with one another, thereby achieving resource isolation and performance isolation of the virtual machines. Moreover, by configuring the operation mode of the bare-metal machines to the non-root mode and then configuring the operation mode of the CPU of the physical machine to the non-root mode, the pass-through application on the physical resources in the physical machine by the virtual machines is achieved, overhead of hardware virtualization is effectively reduced, and the high performance of the physical machine and the virtual machines is ensured.

In a possible embodiment, the bare-metal machines are obtained by segmenting the physical resources of the physical machine in the following manners.

Bare-metal machine configuration information is acquired through a user-mode virtualization component after a host operating system of the physical machine is started. The user-mode virtualization component may be a QEMU. After the host operating system of the physical machine is started, allocation information about the physical resources may be set by the setting an interface, so that the bare-metal machine configuration information may be generated based on user's input parameters. The bare-metal machine configuration information may include the number of bare-metal machines as well as CPU information, memory information and required IO device information of each bare-metal machine. If there is a parameter which is not input by the user, a default parameter may be used.

The physical resources of the physical machine are segmented according to the bare-metal machine configuration information to obtain the bare-metal machines. The physical resources include CPUs, memories and IO devices.

As shown in FIG. 2, if the number of the bare-metal machines is set to two, a bare-metal machine BM1 and a bare-metal machine BM2 may be obtained by segmenting the physical resources of the physical machine.

Thus, through the above technical solution, segmentation setting may be performed for the bare-metal machines in advance after the physical machine is started, so that the required CPUs, memories and IO devices may be segmented from the physical resources of the physical machine to the corresponding bare-metal machines so as to facilitate application of subsequent creation of virtual machines and improve the virtual machine resource allocation rationality and the virtual machine creation efficiency.

In a possible embodiment, an exemplary implementation mode of configuring the operation mode of the bare-metal machines to the non-root mode is as follows. This step may include the followings.

An interrupt control register in the physical machine is configured to be in a pass-through non-root mode, so that an operating system of the virtual machine sends an inter-processor interrupt through the interrupt control register.

The interrupt control register may be an inter-processor interrupt (IPI) register, and the kernel-mode virtualization component may configure the IPI register to be in the pass-through non-root mode through the VMCS. In the related art, when the virtual machine needs to send the inter-processor interrupt, the inter-processor interrupt is trapped in the host operating system, then the host operating system simulates an interrupt for the operating system of the virtual machine, for use by the operating system of the virtual machine, such as presenting a virtual value of the register of the interrupt to the operating system of the virtual machine. In the embodiments of the present disclosure, the operating system of the virtual machine may directly access the IPI register through the above configuration, so as to directly send the inter-processor interrupt based on the IPI register.

A maskable interrupt of the CPU of the physical machine is configured to be in the pass-through non-root mode and a non-maskable interrupt of the CPU is configured to be in a non-pass-through mode, so that an interrupt of the operating system of the virtual machine is the maskable interrupt and an interrupt of the host operating system of the physical machine is the non-maskable interrupt.

An interrupt caused inside the CPU is called an internal interrupt, and an interrupt caused outside the CPU is called an external interrupt. External interrupts include maskable interrupts and the non-maskable interrupt. The interrupt that the CPU may not respond to is the maskable interrupt, while the external interrupt that the CPU must respond to is the non-maskable interrupt.

Exemplarily, the interrupt used by the operating system of the virtual machine is the maskable interrupt and thus the maskable interrupt may be directly allocated to the virtual machine for pass-through application in the embodiment. To avoid interrupt conflicts between the virtual machine and the physical machine, the non-maskable interrupt may be allocated to the host operating system. As a result, when an interrupt arrives in the operating system of the virtual machine, the interrupt is passed through to an interrupt handler of the operating system of the virtual machine in the non-root mode for interrupt handling.

Correspondingly, the method further includes the following steps.

The CPU exits the non-root mode in terms of the operation mode if a target non-maskable interrupt is received from the host operating system.

As described above, both the maskable interrupt and the non-maskable interrupt in the host operating system are sent in the form of the non-maskable interrupt. Therefore, when the host operating system wants to send the maskable interrupt, the maskable interrupt is sent in the form of the non-maskable interrupt. If the target non-maskable interrupt is received from the host operating system, the target non-maskable interrupt is a non-maskable interrupt corresponding to the maskable interrupt that the host operating system wants to send. In this case, the CPU exits the non-root mode in terms of the operation mode and is trapped in the host operating system to handle the interrupt of the host operating system.

The host operating system sends, to the host operating system itself, a maskable interrupt corresponding to an interrupt vector number of the non-maskable interrupt, so as to enter an interrupt handler of the host operating system for interrupt handling.

Subsequently, the host operating system may send, to the host operating system itself, the maskable interrupt corresponding to the interrupt vector number of the non-maskable interrupt through Self-IPI, so that the process in which the host operating system sends the maskable interrupt is achieved to enter the interrupt handler of the host operating system for handling the maskable interrupt.

Interrupt service routines (ISR) specified for the interrupt may be performed upon its arrival, during which an interrupt controller may translate an electrical interrupt signal acquired thereby into the interrupt vector number and submit the same to the CPU. The CPU may determine, based on the interrupt vector number, an object of the interrupt and an interrupt handling way and thus handles the interrupt. The way to acquire the interrupt vector number is a regular operation for interrupt handling, and is not repeated here.

Thus, through the above technical solution, the maskable interrupts may be passed through to the operating system of the virtual machine for use, so that when the interrupt arrives in the operating system of the virtual machine, the interrupt is passed through to the interrupt handler of the operating system of the virtual machine in the non-root mode for interrupt handling, thereby improving the interrupt pass-through stability. Moreover, the non-maskable interrupts are allocated to the host operating system for use to avoid conflicts for use of interrupts between the host operating system and the operating system of the virtual machine, and meanwhile, non-maskable interrupts corresponding to maskable interrupts sent by the host operating system may be converted to ensure the execution stability and security of the host operating system and improve the performance of the physical machine and the virtual machines.

In a possible embodiment, another exemplary implementation mode of configuring the operation mode of the bare-metal machines to the non-root mode is as follows. On the basis of the description above, this step may further include the following steps.

A performance monitoring unit register in the physical machine is configured to be in the pass-through non-root mode, so that the bare-metal machine accesses a performance monitoring unit.

The performance monitoring unit register may be a performance monitor unit (PMU) register that contains a plurality of counters and may collect various statistical information about the processor and memory. Through this configuration, the bare-metal machine can directly access the performance monitoring unit, achieving direct access of the operating system of the virtual machine to the PMU register.

A local advanced programmable interrupt controller (LAPIC) is configured to be in an x2APIC mode and a model-specific register (MSR) corresponding to a clock source, i.e., the local APIC timer, of the local advanced programmable interrupt controller is configured to be in the pass-through non-root mode, so that this clock source, i.e., the local APIC timer, may be passed through to the virtual machine for use.

In the x2APIC mode, APIC registers are read by means of MSRs instead of memory mapping. A part of MSR address intervals is reserved for the APIC registers so as to access the APIC via the MSR.

Exemplarily, the MSR may include a local vector table, a current count register, an initial count register, a divide configuration register and the like, and may be configured according to a specific hardware environment. The kernel-mode virtualization component may configure the MSR register corresponding to the clock source timer to be in the pass-through non-root mode by configuring the VMCS. Specific configuration parameters may be determined according to a VMCS configuration mode in the art and are not repeated here.

Accordingly, the method further includes the following step.

A high-precision event timer is configured as a clock source of the host operating system of the physical machine.

Each CPU only has one clock source Timer. In the related art, the Timer is provided to the host operating system for use, and the Timer used by the operating system of the virtual machine is a Timer that is simulated by the host operating system through trap and exit. In this embodiment, after the Timer is passed through to the operating system of the virtual machine, the operating system of the virtual machine may directly use the physical Timer to determine clock parameter information. In this case, this is no available clock source in the host operating system, in order to avoid the conflict between the host operating system and the operating system of the virtual machine, the high precision event timer (HPET) may be assigned to the host operating system in this embodiment, that is, the HPET is used as the clock source of the host operating system.

Thus, through the above technical solution, the hardware pass-through of the local advanced programmable interrupt controller (LAPIC) of the bare-metal machine can be realized, so that the operating system of the virtual machine can directly access the performance monitor unit (PMU), and the operating system of the virtual machine is avoided from exit. Meanwhile, the clock source may be passed through to the operating system of the virtual machine for use, and the other clock source is assigned to the host operating system, so that conflicts between the host operating system and the operating system of the virtual machine is avoided while avoiding overhead of clock virtualization and IPI virtualization, thereby improving the availability and stability of the virtual machine.

In a possible embodiment, an exemplary implementation mode of configuring the operation mode of the bare-metal machine to the non-root mode is as follows. This step may include the following steps.

A physical address corresponding to a memory allocated for the bare-metal machine in the physical machine is determined.

The operating system itself of the virtual machine has a virtual address space, which is represented by a guest virtual address (GVA). The virtual machine considers that it has the entire memory space, which is represented by a guest physical address (GPA). The host operating system itself has a virtual machine address space, which is represented by a host virtual address (HVA). A host itself has a physical memory space, which is represented by the host physical address (HPA).

In the existing virtualization technology, QEMU allocates an HVA space in the virtual address space of the host, the HVA space corresponds to the GPA space of the virtual machine, and the physical address considered by the virtual machine is essentially a logical address, which is usually addressed from 0 GB.

As shown in FIG. 2, in the embodiment of the present disclosure, the memory of the physical machine may be segmented to obtain the physical address of the memory corresponding to the bare-metal machine BM1 of 0 GB-mGB, and the physical address of the memory corresponding to the bare-metal machine BM2 of m+1 GB-nGB.

The physical address is configured to be a guest physical address of the bare-metal machine, and an extended page table virtualization mode is disabled, so that the bare-metal machine accesses the memory based on the guest physical address.

As mentioned above, in the existing virtualization technology, when the virtual GPA of the BM2 is determined, it is mapped to an address starting from 0 GB, and thus when the virtual machine is addressed, mapping needs to be performed through an extended page table (EPT). However, in the embodiment of the present disclosure, the physical address may be configured as the guest physical address of the bare-metal machine, that is, the HPA of the physical memory that is segmented is used as the GPA of the bare-metal machine. Exemplarily, an e820 table may be transmitted to the operating system of the virtual machine, so that the operating system of the virtual machine may directly use the memory layout of the physical machine and then access data in the physical machine directly based on the GPA address. In addition, since the GPA in the bare-metal machine is the same as the HPA in the physical machine, there is no need for the EPT to perform additional address translation, which further improves the data access efficiency of the virtual machine, and also avoids the overhead of existing memory virtualization, realizes the pass-through between the memory and the bare-metal machine and improves the comprehensiveness of hardware pass-through, thereby improving the user experience.

In a possible embodiment, an exemplary implementation mode of configuring the operation mode of the bare-metal machine to the non-root mode is as follows. This step may also include the following step.

A memory management unit is configured to disable an IOMMU page table, so that the bare-metal machine performs memory management based on a direct memory access mode.

Exemplarily, in the related art, the memory management unit may be an input/output memory management unit (IOMMU), which allows the device to address in a virtual memory, that is, to map the virtual memory address to a physical memory address, so that a physical device may work in a virtual memory environment. Therefore, in the related art, the IOMMU needs to remap an address accessed by hardware according to a translation table between the GPA and the HPA.

As mentioned above, in the embodiment of the present disclosure, as the GPA in the bare-metal machine is the same as the HPA in the physical machine, the IOMMU page table is no longer required for additional address translation in a direct memory access (DMA) process, and memory management and access may be performed directly based on the GPA. In this way, the IOMMU page table may be directly disabled, so that the overhead of the existing I/O virtualization can be avoided and the pass-through between the DMA and the bare-metal machine can be realized, thereby further improving the VM resource allocation effectiveness and improving I/O access efficiency.

It should be noted that the specific implementation modes of configuring the operation mode of the bare-metal machine to the non-root mode described above may be implemented together, so that the overhead of hardware virtualization can be further reduced and the impact on the performance of the physical machine can be reduced.

The present disclosure provides an apparatus of virtual machine resource allocation, the apparatus comprising:
An allocating module 100, for allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
A first configuring module 200, for configuring an operation mode of the bare-metal machines to a non-root mode;
A first switching module 300, for switching an operation mode of a CPU of the physical machine to the non-root mode so as to start the virtual machines in the bare-metal machines.

Optionally, the first configuring module comprises:
A first configuring sub-module, for configuring an interrupt control register in the physical machine to be in a pass-through non-root mode, so that an operating system of the virtual machine sends inter-processor interrupts through the interrupt control register; and
A second configuring sub-module, for configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt;

The apparatus further comprises:
A second switching module, for exiting the non-root mode in terms of the operation mode of the CPU if a target non-maskable interrupt is received from the host operating system;
A sending module, for sending a maskable interrupt, which corresponds to an interrupt vector number of the non-maskable interrupt, to the host operating system itself, so as to enter an interrupt handler of the host operating system for interrupt handling.

Optionally, the first configuring module further comprises:
A third configuring sub-module, for configuring a performance monitor unit register in the physical machine to be in the pass-through non-root mode, so that the bare-metal machine accesses a performance monitor unit;
A fourth configuring sub-module, for configuring a local advanced programmable interrupt controller to be in an x2APIC mode; and
A fifth configuring sub-module, for configuring a model-specific register corresponding to a clock source of the local advanced programmable interrupt controller to be in the pass-through non-root mode;

The apparatus further comprises:
A second configuring module, for configuring a high-precision event timer as a clock source of the host operating system of the physical machine.

Optionally, the first configuring module further comprises:
A determining module, for determining a physical address corresponding to a memory allocated for the bare-metal machine in the physical machine;
A sixth configuring sub-module, for configuring the physical address to be a guest physical address of the bare-metal machine, and disabling an extended page table virtualization mode, so that the bare-metal machine accesses the memory based on the guest physical address.

Optionally, the first configuring module further comprises:

A seventh configuring sub-module, for configuring a memory management unit to disable an IOMMU page table, so that the bare-metal machine performs memory management based on a direct memory access mode.

Optionally, the bare-metal machines are obtained by segmenting the physical resources of the physical machine in the following manners:
Acquiring bare-metal machine configuration information through a user-mode virtualization component after the host operating system of the physical machine is started;
Segmenting the physical resources of the physical machine according to the bare-metal machine configuration information to obtain the bare-metal machines, wherein the physical resources comprise CPUs, memories and IO devices.

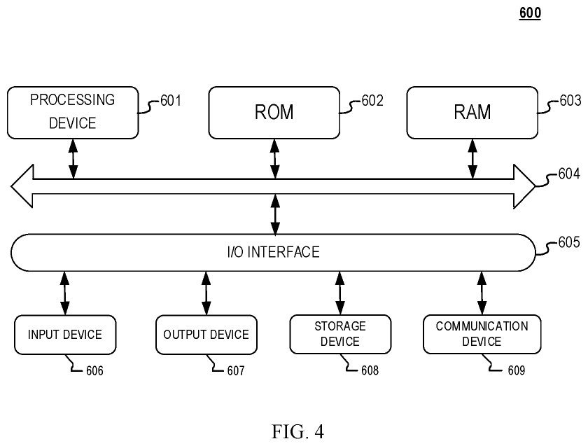

Referring now to FIG. 4, which shows a schematic structural diagram of an electronic device 600 suitable for implementing the present disclosure embodiment. Terminal devices in the present disclosure may include but are not limited to mobile phones, laptops, digital broadcast receivers, PDAs (personal digital assistants), PADs (tablets), PMPs (portable multimedia players), vehicle devices (such as vehicle navigation devices), and fixed terminal devices such as digital TVs, desktop computers, etc. The electronic device shown in FIG. 4 is only an example and should not limit the functionality and scope of use of the present disclosure embodiment.

As shown in FIG. 4, the electronic device 600 may include a processing device (such as a central processor, graphics processing unit, etc.) 601, which may perform various appropriate actions and processes based on programs stored in a read-only memory (ROM) 602 or loaded from a storage device 608 into a random access memory (RAM) 603. In RAM 603, various programs and data required for the operation of the electronic device 600 are also stored. The processing device 601, ROM 602, and RAM 603 are connected to each other through a bus 604. The input/output (I/O) interface 605 is also connected to the bus 604.

Generally, the following devices can be connected to the I/O interface 605: input devices 606, including touch screens, touchpads, keyboards, mice, cameras, microphones, accelerometers, gyroscopes, etc.; output devices 607, including liquid crystal displays (LCDs), speakers, vibrators, etc.; storage devices 608, including magnetic tapes, hard disks, etc.; and communication devices 609. Communication devices 609 can allow electronic devices 600 to communicate wirelessly or wirelessly with other devices to exchange data. Although FIG. 4 shows an electronic device 600 with various devices, it should be understood that it is not required to implement or have all of the devices shown. More or fewer devices may be implemented or provided alternatively.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from the network through the communication device 609, or is installed from the storage device 608, or is installed from the ROM 602. When the computer program is executed by the processing device 601, the above-described functions defined in the method of the present disclosure are performed.

It should be noted that the computer-readable medium described above in this disclosure can be a computer-readable signal medium or a computer-readable storage medium or any combination thereof. The computer-readable storage medium can be, for example, but not limited to, an electrical, magnetic, optical, electromagnetic, infrared, or semiconductor system, device, or any combination thereof. More specific examples of computer-readable storage media may include but are not limited to: an electrical connection with one or more wires, a portable computer disk, a hard disk, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In this disclosure, a computer-readable storage medium may be any tangible medium containing or storing a program that may be used by or in conjunction with an instruction execution system, apparatus, or device. In this disclosure, a computer-readable signal medium may include a data signal propagated in a baseband or as part of a carrier wave, which carries computer-readable program code. Such propagated data signals may take many forms, including but not limited to electromagnetic signals, optical signals, or any suitable combination thereof. Computer-readable signal media may also be any computer-readable medium other than computer-readable storage media, which may send, propagate, or transmit programs for use by or in conjunction with instruction execution systems, apparatuses, or devices. The program code contained on the computer-readable medium can be transmitted using any suitable medium, including but not limited to: wires, optical cables, RF (radio frequency), etc., or any suitable combination thereof.

In some embodiments, the client and server may communicate by using any currently known or future developed network protocol such as HTTP (HyperText Transfer Protocol), and may be interconnected with any form or medium of digital data communication (e.g., a communication network). Examples of communication networks include local area network (“LAN”), wide area network (“WAN”), the Internet (e.g., the Internet), and end-to-end networks (e.g., ad hoc end-to-end networks), as well as any currently known or future developed networks.

The computer-readable medium may be included in the electronic device, or it may exist alone and not assembled into the electronic device.

The above-mentioned computer-readable medium carries one or more programs, and when the above-mentioned one or more programs are executed by the electronic device, the electronic device is caused to: allocate corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines; configure an operation mode of the bare-metal machines to a non-root mode; switch an operation mode of a CPU of the physical machine to the non-root mode so as to start the virtual machines in the bare-metal machines.

Computer program code for performing the operations of the present disclosure may be drafted in one or more programming languages, or combinations thereof, including but not limited to object-oriented programming languages, such as, Java, Smalltalk, C++, and also including conventional procedural programming languages such as “C” language or similar programming languages. The program code may be executed entirely on the computer of the user, partially on the computer of the user, as a standalone software package, partially on the user's computer, or entirely on the remote computer or server. In the case of a remote computer, the remote computer may be connected to the user's computer through any type of network, including a local area network (LAN) or a wide area network (WAN), or may be connected to an external computer (e.g., using an Internet service provider to connect via the Internet).

The flowcharts and block diagrams in the accompanying drawings illustrate the architecture, functions, and operations of systems, methods, and computer program products that may be implemented in accordance with various embodiments of the present disclosure. in this regard, each block in the flowchart or block diagram may represent a module, program segment, or portion of code that contains one or more executable instructions for implementing a specified logical function. It should also be noted that in some alternative implementations, the functions marked in the blocks may also occur in a different order than those marked in the figures. For example, two blocks represented in succession may actually be executed substantially in parallel, and they may sometimes be executed in the opposite order, depending on the function involved. It should also be noted that each block in the block diagram and/or flowchart, and combinations of blocks in the block diagram and/or flowchart, may be implemented using a dedicated hardware-based system that performs the specified function or operation, or may be implemented using a combination of dedicated hardware and computer instructions.

The modules described in the disclosed embodiments can be implemented by software or hardware. The name of the module does not limit the module itself in some cases. For example, the allocation module can also be described as “when creating a virtual machine in TCE-metal, assign the corresponding bare metal device module to the virtual machine.”

The functions described above herein may be performed at least in part by one or more hardware logic components. For example, without limitation, exemplary types of hardware logic components that may be used include: field programmable gate arrays (FPGAs), application specific integrated circuits (ASICs), application specific standard products (ASSPs), system-on-chip (SOCs), complex programmable logic devices (CPLDs), and the likes.

In the context of this disclosure, machine-readable media can be tangible media that can contain or store programs for use by or in conjunction with instruction execution systems, devices, or devices. Machine-readable media can be machine-readable signal media or machine-readable storage media. Machine-readable media may include, but may be not limited to, electronic, magnetic, optical, electromagnetic, infrared, or semiconductor systems, apparatuses, or devices, or any suitable combination thereof. More specific examples of machine-readable storage media may include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination thereof.

According to one or more of the present discourse, example 1 provides a method of virtual machine resource allocation, wherein the method comprises:
Allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
Configuring an operation mode of the bare-metal machines to a non-root mode;
Switching an operation mode of a CPU of the physical machine to the non-root mode so as to start the virtual machines in the bare-metal machines.

According to one or more of the present discourse, example 2 provides a method of example 1, configuring the operation mode of the bare-metal machine to the non-root mode comprises:
Configuring an interrupt control register in the physical machine to be in a pass-through non-root mode, so that an operating system of the virtual machine sends inter-processor interrupts through the interrupt control register;
Configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt;

The method further comprises:
Exiting the non-root mode in terms of the operation mode of the CPU if a target non-maskable interrupt is received from the host operating system;
Sending a maskable interrupt, which corresponds to an interrupt vector number of the non-maskable interrupt, to the host operating system itself, so as to enter an interrupt handler of the host operating system for interrupt handling.

According to one or more of the present discourse, example 3 provides a method of example 2, configuring the operation mode of the bare-metal machine to the non-root mode further comprises:
Configuring a performance monitor unit register in the physical machine to be in the pass-through non-root mode, so that the bare-metal machine accesses a performance monitor unit;
Configuring a local advanced programmable interrupt controller to be in an x2APIC mode;
Configuring a model-specific register corresponding to a clock source of the local advanced programmable interrupt controller to be in the pass-through non-root mode; and

The method further comprises:
Configuring a high-precision event timer as a clock source of the host operating system of the physical machine.

According to one or more of the present discourse, example 4 provides a method of example 1, configuring the operation mode of the bare-metal machine to the non-root mode further comprises:
Determining a physical address corresponding to a memory allocated for the bare-metal machine in the physical machine;
Configuring the physical address to be a guest physical address of the bare-metal machine, and disabling an extended page table virtualization mode, so that the bare-metal machine accesses the memory based on the guest physical address.

According to one or more of the present discourse, example 5 provides a method of example 1, configuring the operation mode of the bare-metal machine to the non-root mode further comprises:
Configuring a memory management unit to disable an IOMMU page table, so that the bare-metal machine performs memory management based on a direct memory access mode.

According to one or more of the present discourse, example 6 provides a method of example 1, the bare-metal machines are obtained by segmenting the physical resources of the physical machine in the following manners:
Acquiring bare-metal machine configuration information through a user-mode virtualization component after the host operating system of the physical machine is started;
Segmenting the physical resources of the physical machine according to the bare-metal machine configuration information to obtain the bare-metal machines, wherein the physical resources comprise CPUs, memories and IO devices.

According to one or more of the present discourse, example 7 provides an apparatus of virtual machine resource allocation, wherein the apparatus comprises:
An allocating module, for allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
A first configuring module, for configuring an operation mode of the bare-metal machines to a non-root mode;
A first switching module, for switching an operation mode of a CPU of the physical machine to the non-root mode so as to start the virtual machines in the bare-metal machines.

According to one or more of the present discourse, example 8 provides the apparatus of example 7, the first configuring module comprises:
A first configuring sub-module, for configuring an interrupt control register in the physical machine to be in a pass-through non-root mode, so that an operating system of the virtual machine sends inter-processor interrupts through the interrupt control register; and
A second configuring sub-module, for configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt;

The apparatus further comprises:
A second switching module, for exiting the non-root mode in terms of the operation mode of the CPU if a target non-maskable interrupt is received from the host operating system;
A sending module, for sending a maskable interrupt, which corresponds to an interrupt vector number of the non-maskable interrupt, to the host operating system itself, so as to enter an interrupt handler of the host operating system for interrupt handling.

According to one or more of the present discourse, example 9 provides a computer-readable storage medium storing a computer program thereon, wherein, the computer program, when is executed by a processor, implements steps of the method according to any of examples 1 to 6.

According to one or more of the present discourse, example 10 provides an electronic device, comprising:
A storage device having at least one computer program stored thereon;
One or more processing devices for executing the at least one computer program in the storage device to implement steps of any of the examples 1-6.

The above description is only the preferred embodiment of the present disclosure and an explanation of the technical principles used. Those skilled in the art should understand that the scope of the disclosure involved in the present disclosure is not limited to the specific combination of the above technical features, but should also cover other technical solutions formed by any combination of the above technical features or their equivalent features without departing from the above disclosure concept. For example, the technical solution formed by replacing the above features with (but not limited to) technical features with similar functions disclosed in the present disclosure.

In addition, although the operations are depicted in a specific order, this should not be understood as requiring these operations to be performed in the specific order shown or in sequential order. Under certain circumstances, multitasking and parallel processing may be advantageous. Similarly, although several specific implementation details are included in the above discussion, these should not be construed as limiting the scope of the present disclosure. Certain features described in the context of individual embodiments may also be implemented in combination in a single embodiment. Conversely, various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the particular features or acts described above. Rather, the particular features and acts described above are merely exemplary forms of implementation of the claims. With respect to the apparatus in the above embodiments, wherein the specific manner in which each module performs operations has been described in detail in the embodiment relating to the method, will not be described in detail herein.

1-10. (canceled)

11. A method of virtual machine resource allocation, comprising:
allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
configuring an operation mode of the bare-metal machines to a non-root mode; and
switching an operation mode of a CPU of the physical machine to the non-root mode so as to start the virtual machines in the bare-metal machines.

12. The method according to claim 11, wherein configuring the operation mode of the bare-metal machine to the non-root mode comprises:
configuring an interrupt control register in the physical machine to be in a pass-through non-root mode, so that an operating system of the virtual machine sends inter-processor interrupts through the interrupt control register; and
configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt.

13. The method according to claim 12, further comprising:
exiting the non-root mode in terms of the operation mode of the CPU if a target non-maskable interrupt is received from the host operating system; and
sending a maskable interrupt, which corresponds to an interrupt vector number of the non-maskable interrupt, to the host operating system itself, so as to enter an interrupt handler of the host operating system for interrupt handling.

14. The method according to claim 12, wherein configuring the operation mode of the bare-metal machine to the non-root mode further comprises:
configuring a performance monitor unit register in the physical machine to be in the pass-through non-root mode, so that the bare-metal machine accesses a performance monitor unit;
configuring a local advanced programmable interrupt controller to be in an x2APIC mode; and
configuring a model-specific register corresponding to a clock source of the local advanced programmable interrupt controller to be in the pass-through non-root mode.

15. The method according to claim 14, further comprising:
configuring a high-precision event timer as a clock source of the host operating system of the physical machine.

16. The method according to claim 11, wherein configuring the operation mode of the bare-metal machine to the non-root mode comprises:
determining a physical address corresponding to a memory allocated for the bare-metal machine in the physical machine; and
configuring the physical address to be a guest physical address of the bare-metal machine, and disabling an extended page table virtualization mode, so that the bare-metal machine accesses the memory based on the guest physical address.

17. The method according to claim 16, wherein configuring the operation mode of the bare-metal machine to the non-root mode further comprises:
configuring a memory management unit to disable an IOMMU page table, so that the bare-metal machine performs memory management based on a direct memory access mode.

18. The method according to claim 11, wherein the bare-metal machines are obtained by segmenting the physical resources of the physical machine in the following manners:
acquiring bare-metal machine configuration information through a user-mode virtualization component after the host operating system of the physical machine is started; and
segmenting the physical resources of the physical machine according to the bare-metal machine configuration information to obtain the bare-metal machines, wherein the physical resources comprise CPUs, memories and IO devices.

19. An electronic device comprising:
a processor; and
a memory for storing a computer program;
wherein the computer program, when executed by the processor, cause the electronic device to perform operations comprising:
allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
configuring an operation mode of the bare-metal machines to a non-root mode; and
switching an operation mode of a CPU of the physical machine to the non-root mode so as to start the virtual machines in the bare-metal machines.

20. The electronic device according to claim 19, wherein configuring the operation mode of the bare-metal machine to the non-root mode comprises:
configuring an interrupt control register in the physical machine to be in a pass-through non-root mode, so that an operating system of the virtual machine sends inter-processor interrupts through the interrupt control register; and
configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt.

21. The electronic device according to claim 20, wherein the operations further comprise:
exiting the non-root mode in terms of the operation mode of the CPU if a target non-maskable interrupt is received from the host operating system; and
sending a maskable interrupt, which corresponds to an interrupt vector number of the non-maskable interrupt, to the host operating system itself, so as to enter an interrupt handler of the host operating system for interrupt handling.

22. The electronic device according to claim 20, wherein configuring the operation mode of the bare-metal machine to the non-root mode further comprises:
configuring a performance monitor unit register in the physical machine to be in the pass-through non-root mode, so that the bare-metal machine accesses a performance monitor unit;
configuring a local advanced programmable interrupt controller to be in an x2APIC mode; and
configuring a model-specific register corresponding to a clock source of the local advanced programmable interrupt controller to be in the pass-through non-root mode.

23. The electronic device according to claim 22, wherein the operations further comprise:
configuring a high-precision event timer as a clock source of the host operating system of the physical machine.

24. The electronic device according to claim 19, wherein configuring the operation mode of the bare-metal machine to the non-root mode comprises:
determining a physical address corresponding to a memory allocated for the bare-metal machine in the physical machine; and
configuring the physical address to be a guest physical address of the bare-metal machine, and disabling an extended page table virtualization mode, so that the bare-metal machine accesses the memory based on the guest physical address.

25. The electronic device according to claim 24, wherein configuring the operation mode of the bare-metal machine to the non-root mode further comprises:
configuring a memory management unit to disable an IOMMU page table, so that the bare-metal machine performs memory management based on a direct memory access mode.

26. The electronic device according to claim 19, wherein the bare-metal machines are obtained by segmenting the physical resources of the physical machine in the following manners:
acquiring bare-metal machine configuration information through a user-mode virtualization component after the host operating system of the physical machine is started; and
segmenting the physical resources of the physical machine according to the bare-metal machine configuration information to obtain the bare-metal machines, wherein the physical resources comprise CPUs, memories and IO devices.

27. A non-transitory computer-readable storage medium, wherein the computer readable-storage medium stores instructions which, when executed on an electronic device, cause the electronic device to perform operations comprising:
allocating corresponding bare-metal machines to virtual machines when the virtual machines are created in a physical machine, wherein the bare-metal machines are obtained by segmenting physical resources of the physical machine, and the virtual machines are in one-to-one correspondence with the bare-metal machines;
configuring an operation mode of the bare-metal machines to a non-root mode; and
switching an operation mode of a CPU of the physical machine to the non-root mode so as to start the virtual machines in the bare-metal machines.

28. The non-transitory computer-readable storage medium of claim 27, wherein configuring the operation mode of the bare-metal machine to the non-root mode comprises:
configuring an interrupt control register in the physical machine to be in a pass-through non-root mode, so that an operating system of the virtual machine sends inter-processor interrupts through the interrupt control register; and
configuring a maskable interrupt of the CPU of the physical machine to be in the pass-through non-root mode and a non-maskable interrupt of the CPU to be in a non-pass-through mode, so that an interrupt of an operating system of the virtual machine is the maskable interrupt and an interrupt of a host operating system of the physical machine is the non-maskable interrupt;
and wherein the operations further comprise:
exiting the non-root mode in terms of the operation mode of the CPU if a target non-maskable interrupt is received from the host operating system; and
sending a maskable interrupt, which corresponds to an interrupt vector number of the non-maskable interrupt, to the host operating system itself, so as to enter an interrupt handler of the host operating system for interrupt handling.

29. The non-transitory computer-readable storage medium of claim 28, wherein configuring the operation mode of the bare-metal machine to the non-root mode further comprises:
configuring a performance monitor unit register in the physical machine to be in the pass-through non-root mode, so that the bare-metal machine accesses a performance monitor unit;
configuring a local advanced programmable interrupt controller to be in an x2APIC mode; and
configuring a model-specific register corresponding to a clock source of the local advanced programmable interrupt controller to be in the pass-through non-root mode,
and wherein the operations further comprise:
configuring a high-precision event timer as a clock source of the host operating system of the physical machine.

30. The non-transitory computer-readable storage medium of claim 27, wherein configuring the operation mode of the bare-metal machine to the non-root mode comprises:
determining a physical address corresponding to a memory allocated for the bare-metal machine in the physical machine; and
configuring the physical address to be a guest physical address of the bare-metal machine, and disabling an extended page table virtualization mode, so that the bare-metal machine accesses the memory based on the guest physical address.
